(19) United States
(12) Patent Application Publication
(10) Pub. No.: US 2017/0283089 A1
(43) Pub. Date: Oct. 5, 2017

(54) Apparatus, System, and Method for Moving an Aircraft

(71) Applicant: Mark Patey, Mapleton, UT (US)

(72) Inventor: Mark Patey, Mapleton, UT (US)

(21) Appl. No.: 15/480,294

(22) Filed: Apr. 5, 2017

Related U.S. Application Data
(60) Provisional application No. 62/318,718, filed on Apr. 5, 2016.

(51) Int. Cl. B64F 1/22; B60P 3/11

(52) U.S. Cl. CPC B64F 1/224; B60P 3/11

(57) ABSTRACT

An apparatus, system, and method are disclosed for moving an aircraft. The apparatus includes an elongated support frame, at least one tug wheel and a loading platform. The elongate support frame includes a wheel receiving recess shaped to receive a wheel of an aircraft. The tug wheel(s) support the elongated support frame. The loading platform is positioned within the wheel receiving space and is configured to support the aircraft wheel. The loading platform is positioned at a height relative to the elongated support frame that is sufficient to avoid interference between a propeller on the aircraft and the elongated support frame when the aircraft wheel is positioned on the loading platform.

### CROSS-REFERENCES TO RELATED APPLICATIONS

This application claims the benefit of United States Provisional Patent Application No. 62/318,718 entitled “AN INTERCHANGEABLE TOWING APPARATUS” and filed on Apr. 5, 2016 for Mark Patey, which is incorporated herein by reference.

### FIELD OF THE INVENTION

This invention relates to taxying aircraft and more particularly relates to aircraft tugs.

### BACKGROUND

Basic movement of smaller aircraft is typically done by hand or by taxiing the aircraft under the aircraft's own power. Movement and steering using human power is often accomplished by pushing or pulling on the physical structure of the aircraft. This can damage an aircraft's fragile structure so it is often advisable to use a tow bar.

To move an aircraft using a tow bar, the tow bar is coupled to either the nose wheel or tail wheel of the aircraft. The user then pushes, pulls, steers and brakes the aircraft using the user's own power on the tow bar to move the aircraft. A less cumbersome method of moving an aircraft involves attaching a powered tug to either the nose wheel or tail wheel of an aircraft. Powered tugs include a motor or engine to assist in moving the aircraft. The addition of a motor or engine causes a powered tug to have a higher profile than a simple tow bar.

One drawback of using a powered tug to move an aircraft is the fact that such tugs have a higher profile and are cumbersome. The increased profile of the tug can interfere with the aircraft's relatively fragile propeller. Contact between the tug and the aircraft's propeller can cause extensive damage to the propeller and/or tug. With a two or three bladed propeller, contact between the blades and tug components can be avoided by rotating the blades to a position where the blades cannot contact the tug components. However, if the blades of the propeller are inadvertently rotated (i.e., by starting the aircraft's engine), the blades of the propeller may encounter the tug components causing damage to the blades. For propellers having more than three blades, the distance between each blade may be insufficient to straddle the tug or, if they are, turning the tug may cause the blades of the propeller to contact the tug components.

A propeller is one of the most highly stressed components on an aircraft. During normal operation, 10 to 25 tons of centrifugal force pull the blades from the hub while the blades are bending and flexing due to thrust and torque loads and engine, aerodynamic and gyroscopic vibratory loads. When propeller components are damaged by striking a relatively solid object (i.e., a tug), the Federal Aviation Administration guidelines indicate that if there is any visible damage to a propeller, such as nicks, corrosion gouges or cracks, the propeller must be removed and sent to an approved repair station. Repairing or replacing the propeller can cost tens of thousands of dollars.

### SUMMARY

From the foregoing discussion, it should be apparent that a need exists for an apparatus, system, and method for moving an aircraft that avoids damage to aircraft propeller blades. Beneficially, such an apparatus, system, and method would minimize or eliminate the potential of a propeller blade to strike an aircraft tug.

The present invention has been developed in response to the present state of the art, and in particular, in response to the problems and needs in the art that have not yet been fully solved by currently available aircraft tugs. Accordingly, the present invention has been developed to provide an apparatus, system, and method for moving an aircraft that overcome many or all of the above-discussed shortcomings in the art.

The apparatus to move an aircraft, in one embodiment, includes an elongated support frame, at least one tug wheel and a loading platform. The elongated support frame includes a wheel receiving recess shaped to receive a wheel of an aircraft. The tug wheel(s) support the elongated support frame. The loading platform is positioned within the wheel receiving space and is configured to support the aircraft wheel. The loading platform is positioned at a height relative to the elongated support frame that is sufficient to avoid interference between a propeller on the aircraft and the elongated support frame when the aircraft wheel is positioned on the loading platform.

In certain embodiments, the elongated support frame includes a top surface and the loading platform includes an aircraft wheel support surface. The top surface of the elongated support frame is positioned at a first height and the aircraft wheel support surface of the loading platform is positioned at a second height. In such embodiments, a difference between the first height (the height of the top surface of the elongated support frame) and the second height (the height of the aircraft wheel support surface) is sufficient to support the aircraft at a position that avoids interference between the propeller on the aircraft and the top surface of the elongated support frame. In one embodiment, the difference between the first height (the height of the top surface of the elongated support frame) and the second height (the height of the aircraft wheel support surface) is less than about seven (7) inches. In an exemplary embodiment, the difference between the first height (the height of the top surface of the elongated support frame) and the second height (the height of the aircraft wheel support surface) is about five (5) inches. In yet another embodiment, the top surface of the elongated support frame is positioned at approximately the same height as the aircraft wheel support surface.

In one embodiment, the first height (the height of the top surface of the elongated support frame) is less than about eight (8) inches. In such an embodiment, the second height (the height of the aircraft wheel support surface) is greater than about two (2) inches. In an exemplary embodiment, the first height (the height of the top surface of the elongated support frame) is about seven (7) inches and the second height (the height of the aircraft wheel support surface) is about two (2) inches.

The apparatus, in certain embodiments, also includes a cowling configured to cover the elongated support frame. In such an embodiment, the difference between the first height (the height of the top surface of the elongated support frame) and the second height (the height of the aircraft wheel support surface) is sufficient to support the aircraft at a position that avoids interference between the propeller on the aircraft and a top surface of the cowling.

In certain embodiments, the apparatus also includes a winch having an elongated strapping material. The winch is configured to draw at least one aircraft wheel onto the loading platform. In such embodiments, the cowling includes a recess extending longitudinally along the cowling. The recess is configured to receive the elongated strapping material to protect the elongated strapping material from contact with the propeller on the aircraft.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a top view illustrating one embodiment of an apparatus for moving an aircraft in accordance with the present subject matter;

FIG. 2A a side cutaway view taken along line A-A of FIG. 1 further illustrating the apparatus for moving an aircraft in accordance with the present subject matter;

FIG. 2B is an enlarged view illustrating area 220 of FIG. 2A in accordance with the present subject matter;

FIG. 3 is a top view illustrating one embodiment of cowling for covering the components of apparatus in accordance with the present subject matter;

FIG. 4 is a perspective view further illustrating one embodiment of the aircraft engagement member of FIG. 1 in accordance with the present subject matter;

FIG. 5A is a top cutaway view taken along line B-B of FIG. 4 further illustrating the apparatus 400 coupleable to a wheel in accordance with the present subject matter;

FIG. 5B is a perspective view further illustrating one embodiment of the first coupling member and the second coupling member in accordance with the present subject matter;

FIG. 6 is a side view illustrating one embodiment of an interchangeable towing apparatus in accordance with the present subject matter;

FIG. 7 depicts a top cutaway view taken along line C-C of FIG. 6 further illustrating the interchangeable towing connector in a closed position in accordance with the present subject matter;

FIG. 8 depicts a top cutaway view taken along line C-C of FIG. 6 further illustrating the interchangeable towing connector in an open position in accordance with the present subject matter; and

FIG. 9 is a side view illustrating one embodiment of the interchangeable towing connector in accordance with the present subject matter.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

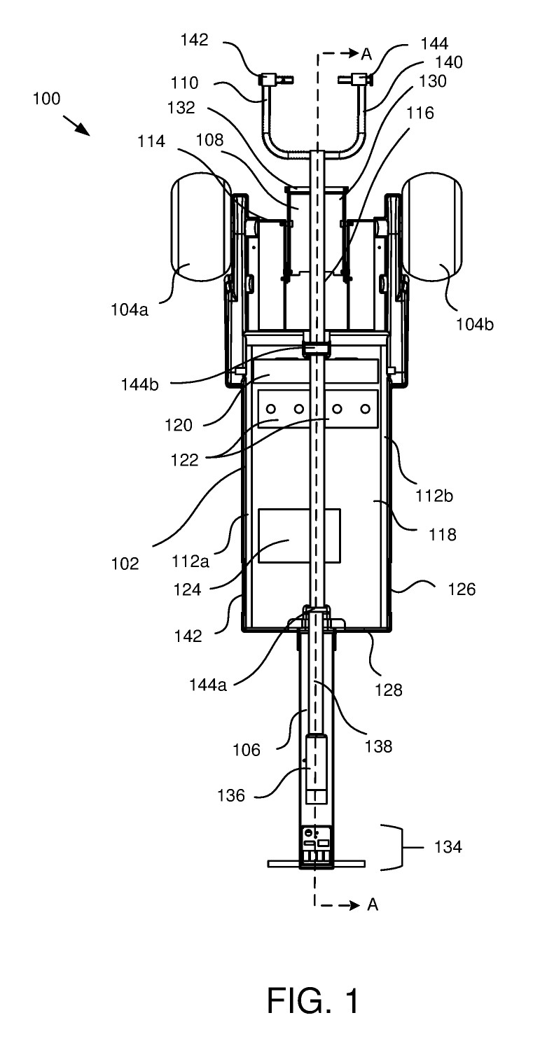

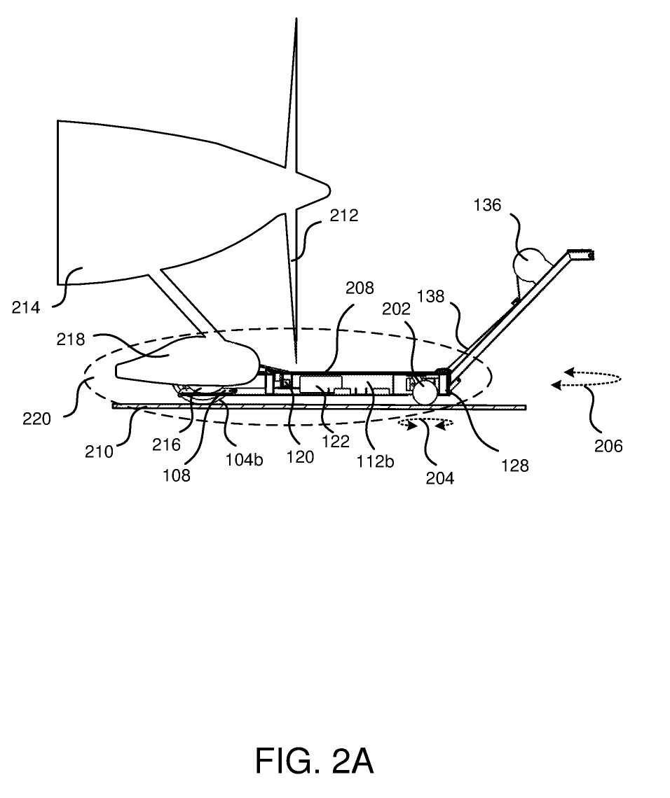

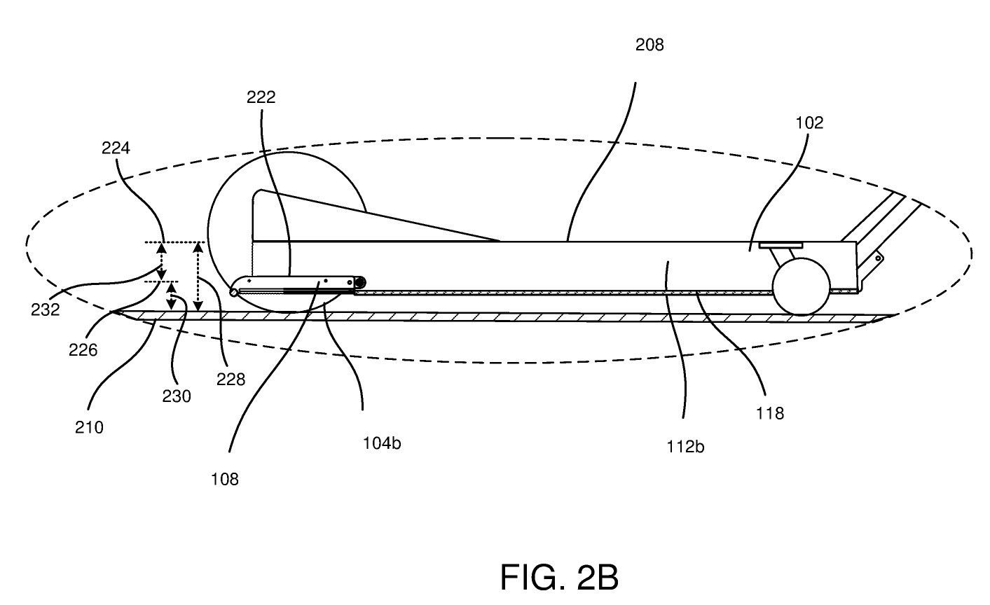

FIG. 1 is a top view illustrating one embodiment of an apparatus 100 for moving an aircraft in accordance with the present subject matter. The apparatus 100, in certain embodiments, is an aircraft tug used to tow an aircraft 214 (see, FIG. 2A) such as an airplane or helicopter. In one embodiment, the apparatus 100 includes an elongated support frame 102, at least one tug wheel 104a and 104b (collectively 104), an elongated handle 106, a loading platform 108, and an aircraft engagement member 110.

The elongated support frame 102, in certain embodiments, is made of a material having sufficient structural rigidity to support the weight of an aircraft 214. The elongated support frame 102 includes a pair of side supports 112a and 112b (collectively 112) that extend along each side of the elongated support frame 102. A support surface 118 is coupled to the side supports 112 and provides a surface for mounting or supporting various components such as a motor 120, batteries 122, and an air compressor 124. In other embodiments, the support surface 118 may support additional accessories.

In one embodiment, a first end 114 of the elongated support frame 102 includes a wheel receiving recess 116 sized to receive an aircraft wheel 216 (see, FIG. 2A). The loading platform 108 is positioned within the wheel receiving recess 116 to assist in positioning the aircraft wheel 216 within the wheel receiving recess 116. In certain embodiments, the loading platform 108 is pivotable within the wheel receiving recess 116 such that an extending end 130 drops down to receive the aircraft wheel 216 to assist with loading the aircraft wheel 216 into the wheel receiving recess 116. Additionally, a rotatable roller 132 may be positioned at the end of the extending end 130 of the loading platform 108 to further assist in positioning the aircraft wheel 216 into the wheel receiving recess 116.

The elongated handle 106 extends from a second end 128 of the elongated support frame 102. The second end 128 of the elongated support frame 102 is the end opposite the wheel receiving recess 116. In use, the elongated handle 106 provides an easy and efficient way to manipulate the elongated support frame 102 and thereby move the aircraft 214. In other embodiments the elongated handle 106 may be omitted and the apparatus may be manipulated using remote controls (not shown).

Tug wheels 104 are positioned on opposing sides of the wheel receiving recess 116. In certain embodiments, tug wheels 104a and 104b are drive wheels which are operably coupled to the motor 120 through a chain, belt, or other gearing arrangement. In other embodiments, only one of the tug wheels 104 is operably coupled to the motor 120 through a chain, belt, or other gearing arrangement. Batteries 122 provide an electrical source to power the motor 120 to selectively rotate the wheel(s) 104 to provide a forward or rearward motion to the wheel(s) 104 to move the elongated support frame 102 in a forward or rearward direction. In certain embodiments, the apparatus 100 includes an internal battery charger 124 for charging the batteries 122.

The apparatus 100 also includes at least one pivotable wheel 202 (see, FIG. 2A). The pivotable wheel(s) 202 is coupled to the elongated support frame 102 at a position near the second end 128 of the elongated support frame 102. The pivotable wheel(s) 202 are pivotable about an axis substantially perpendicular to the plane of the elongated support frame 102 such that the pivotable wheel(s) 202 can rotate in the direction indicated by line 204 (see, FIG. 2A). This allows the second end 128 of the elongated support frame 102 to pivot about one of the two drive tug wheels 104 to rotate the elongated support frame 102 and swing the elongated support frame 102 in the direction indicated by line 206 (see, FIG. 2A).

The drive tug wheels 104 and the pivotable wheel(s) 202 support the elongated support frame 102 such that a top surface 208 (see, FIG. 2A) of the elongated support frame 102 is positioned at a predefined distance above a surface 210 (see, FIG. 2A) over which the apparatus 100 will travel. In one embodiment, the predefined distance is a low enough height sufficient to avoid interference with a propeller 212 (see, FIG. 2A) on the aircraft 214 when the wheel 216 of the aircraft 214 is positioned on the loading platform 108. In certain embodiments, the predefined distance at which the top surface 208 of the elongated support frame 102 is positioned is a height of less than about 8 inches. In an exemplary embodiment, the predefined distance at which the top surface 208 of the elongated support frame 102 is positioned is a height of less than about 7.54 inches. It has been found that positioning top surface 208 of the elongated support frame 102 at a height of less than about 8 inches is sufficient to avoid interference with the propeller 212 on the aircraft 214 when the wheel 216 of the aircraft 214 is positioned on the loading platform 108. Of course, one of skill in the art will recognize that aircraft 214 having smaller or larger propellers 212 will allow for differing heights as long as the top surface 208 of the elongated support frame 102 is positioned at a height to avoid interference with the propeller 212 of the aircraft 214.

The batteries 122 may also be used to power additional accessories such as the air compressor 124 or an Auxiliary Power Unit or jump starter 126. In certain embodiments, the air compressor 124 may be used to inflate or top off the tug wheels 104 on the apparatus 100. Of course, one of skill in the art will recognize that the air compressor may be used to inflate or top off the wheels 216 of the aircraft 214 or any other vehicles wheels as well. The jump starter 126 may be used to jump start the aircraft 214 if the need arises. Additional accessories may be positioned on the apparatus 100 to perform other common maintenance on the aircraft 214. In an exemplary embodiment, the batteries 122, the motor 120, the air compressor 124, the jump starter 126 and any accessories are positioned at a low enough height sufficient to avoid interference with the propeller 212 of the aircraft 214.

Controls 134 (i.e., electrical switches and/or a twist throttle) are positioned on the elongated handle 106 to control the motor 120 and various accessories. In certain embodiments, the 134 are programmable such that the apparatus 100 can be programmed for smooth forward and rearward motion. Smooth forward and rearward motion avoids unnecessary stress on the aircraft's 214 landing gear caused by rapid motion of the apparatus 100. In certain embodiments, the controls 134 also includes a parking brake mechanism that is only unlocked when the apparatus 100 has electrical power. Thus, if the batteries 122 of the apparatus 100 are drained due to a fault or other failure, the apparatus 100 acts as a brake to avoid movement of the aircraft 214. In an exemplary embodiment, once the throttle is released, the motor 120 provides an anti-torque to slow and stop movement of the apparatus 100.

The throttle, in certain embodiments, is programmable by the user to deliver spikes of direct current to the motor 120 utilizing computer controlled pulse wave modulation such that the motor 120 delivers full torque regardless of the revolutions per minute. This allows the user to decide the speed at which the apparatus 100 will move and offers greater control of the apparatus 100 than would be otherwise achieved.

The aircraft engagement member 110 is coupleable to the aircraft 214. In certain embodiments, the aircraft engagement member 110 is a length of material (not shown) positionable about a physical element of the aircraft 214 (i.e., an aircraft wheel 216 or any other physical part of the aircraft 214). The length of material (not shown) can be any pliable material for encircling a physical element of the aircraft 214 (i.e., a chain, rope, chord, strap, etc.)

In the embodiment illustrated in FIG. 1, the aircraft engagement member 110 is a U-shaped bar 140. Each end 142 and 144 of the U-shaped bar 140 are positionable on either side of either the nose wheel 216 or tail wheel of the aircraft 214. The ends 142, 144 of the U-shaped bar 140 are configured to engage either an axle on the nose wheel 216 or tail wheel of the aircraft 214 or a towing fixture operably coupled to the nose wheel 216 or tail wheel of the aircraft 214.

A winch 136 is coupled to the elongated handle 106. The winch 136 includes an elongated strapping material 138 that extends therefrom. Rotation of the winch 136 in a first direction operates to increase the length of the elongated strapping material 138 extending from the winch 136. Rotation of the winch 136 in a second direction operates to decrease the length of the elongated strapping material 138 extending from the winch 136.

The elongated strapping material 138 is coupleable to the aircraft engagement member 110 (i.e., either the length of material (not shown) or the U-shaped bar 140). With the aircraft engagement member 110 coupled to the aircraft 214 and the elongated strapping material 138 coupled to the aircraft engagement member 110, the aircraft wheel 216 can be positioned into the wheel receiving recess 116 and onto the loading platform 108 by rotating the winch 136 in the second direction to decrease the length of the elongated strapping material 138 extending from the winch 136. In embodiments wherein the engagement member 110 is a U-shaped bar 140, the U-shaped bar 140 may be sized slightly narrower than the wheel receiving recess 116 to accommodate side to side movement of the wheel 216 as the wheel 216 is drawn into the wheel receiving recess 116.

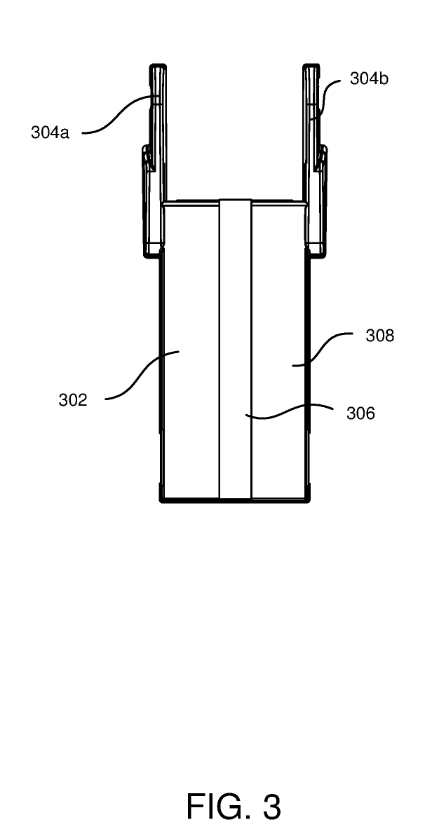

Upon starting an aircraft 214, rotation of the propeller 212 creates a vacuum that can disrupt the elongated strapping material 138 and cause it to become entangled with the propeller 212 of the aircraft 214. Accordingly, in certain embodiments, the apparatus 100 includes one or more strapping material guides 144a and 144b (collectively 144). The strapping material guides 144 position the elongated strapping material 138 adjacent the elongated handle 106 and adjacent the elongated support frame 102 to avoid entanglement between the propeller 212 and the elongated strapping material 138. As is further discussed below, in certain embodiments, the apparatus 100 also includes a cowling 302 (see FIG. 3) that covers the elongated strapping material 138 keeping the propeller 212 and the elongated strapping material 138 separated.

FIG. 2A a side cutaway view taken along line A-A of FIG. 1 further illustrating the apparatus 100 in accordance with the present subject matter. In the embodiment illustrated in FIG. 2A, the aircraft engagement member 110 has been coupled to the aircraft's wheel 216 or a towing fixture operably coupled to the nose wheel 216 and the aircraft's wheel 216 has been positioned on the loading platform 108. In this position, the aircraft 214 is ready to be transported with the propeller 212 spaced at a distance from the apparatus 100 to avoid damage to the propeller 212 should the pilot start the aircraft's engine while the apparatus 100 is coupled to the aircraft 214. Notably, the weight of at least a portion of the aircraft 214 rests on the apparatus 100 to increase traction of the drive tug wheels 104.

FIG. 2B is an enlarged view illustrating area 220 of FIG. 2A in accordance with the present subject matter. In the embodiment illustrated in FIG. 2B, the various components disposed on the support surface 118 of the elongated support frame 102 have been omitted to more clearly illustrate side support 112b of the elongated support frame 102 and the loading platform 108.

As discussed above, the side supports 112 of the elongated support frame 102 have a top surface 208. As used herein, the top surface 208 of the side supports 112 may also be referred to as the top surface 208 of the elongated support frame 102. The loading platform 108 has an aircraft wheel support surface 222 (i.e., the top surface of the loading platform 108).

The top surface 208 of the elongated support frame 102 is positioned at a first height 224 above the surface 210 over which the apparatus 100 will travel (i.e., the ground) by virtue of the tug wheels 104 supporting the elongated support frame 102 at a first height (i.e., a first predefined distance above the support surface 210) as indicated by arrow 228. Because the loading platform 108 is coupled to the elongated support frame 102, the tug wheels 104 also support the aircraft wheel support surface 222 of the loading platform 108 at a second height (i.e., a second predefined distance above the support surface 210) as indicated by arrow 230.

One of skill in the art will recognize that the minimum ground clearance of a conventional aircraft propeller 212 is eight (8) inches. Accordingly, in certain embodiments, the apparatus 100 is configured to maintain at least eight (8) inches of clearance between the aircraft propeller 212 and the top surface 208 of the elongated support frame 102 when the aircraft 214 is positioned on the loading platform 108. This avoids interference or contact between the propeller 212 on the aircraft and the top surface 208 of the elongated support frame 102.

For example, in certain embodiments, the first height 224 (i.e., the height of the top surface 208 of the elongated support frame 102) and the second height 230 (i.e., the height of the aircraft wheel support surface 222 of the loading platform 108) are configured such that the overall difference (as indicated by arrow 232) in the first height 224 and the second height 230 is less than about seven (7) inches. It has been found that a height differential between the first height 224 and the second height 230 of about seven (7) inches between provides sufficient clearance between the propeller 212 and the top surface 208 of the elongated support frame 102 to avoid interference between the propeller 212 on the aircraft 214 and the top surface 208 of the elongated support frame 102. In certain embodiments, to account for variations in the propeller 212, the apparatus 100 may be configured such that the difference 232 between the first height 224 and the second height 230 is about five (5) inches.

Of course, one of skill in the art will recognize that the difference 232 between the first height 224 of the top surface 208 of the elongated support frame 102 and the second height 230 of the aircraft wheel support surface 222 of the loading platform 108 may be less than seven (7) inches to avoid interference between the aircraft propeller 212 and the top surface 208 of the elongated support frame 102. For example, in certain embodiments, there may not be a difference 232 between the first height 224 of the top surface 208 of the elongated support frame 102 and the second height 230 of the aircraft wheel support surface 222 of the loading platform 108. That is, in one embodiment, the first height 224 of the top surface 208 of the elongated support frame 102 may be substantially the same height as the first height 224 of the top surface 208 of the elongated support frame 102. This simply provides additional clearance between the top surface 208 of the elongated support frame 102 and the propeller 212 on the aircraft 214.

In one embodiment, to maintain sufficient clearance between the aircraft propeller 212 and the top surface 208 of the elongated support frame 102, the first height 224 of the top surface 208 of the elongated support frame 102 is less than about eight (8) inches. To maintain a propeller 212 clearance of at least eight (8) inches, the support surface 222 of the loading platform 108 should be raised such that the difference 232 between the first height 224 of the top surface 208 of the elongated support frame 102 and the second height 230 of the aircraft wheel support surface 222 of the loading platform 108 is less than eight (8) inches. In an exemplary embodiment, the second height 230 of the aircraft wheel support surface 222 of the loading platform 108 is greater than about one (1) inch.

In other embodiments, the first height 224 of the top surface 208 of the elongated support frame 102 is greater than eight (8) inches. In such embodiments, the second height 230 of the aircraft wheel support surface 222 of the loading platform 108 is adjusted to maintain at least eight (8) inches of clearance between the top surface 208 of the elongated support frame 102 and the propeller 212 of the aircraft 214.

In yet another embodiment, the second height 230 of the aircraft wheel support surface 222 of the loading platform 108 is higher than the first height 224 of the top surface 208 of the elongated support frame 102. In such an embodiment, the apparatus maintains at least eight (8) inches of clearance between the top surface 208 of the elongated support frame 102 and the propeller 212 of the aircraft 214.

FIG. 3 is a top view illustrating one embodiment of cowling 302 for covering the components of apparatus 100 in accordance with the present subject matter. In certain embodiments, the apparatus 100 may include a cowling 302 to cover and protect the elongated strapping material 138 and to prevent entanglement between the elongated strapping material 138 and the propeller 212 of the aircraft 214. Beneficially, the cowling 302 also protects the various components positioned on the support surface 118 of the elongated support frame 102.

In embodiments wherein the apparatus includes a cowling 302, the difference 232 between the first height 224 and the second height 230 is sufficient to support the aircraft 214 at a position that avoids interference between the propeller 212 on the aircraft 214 and a top surface 308 of the cowling 302. As discussed above, the difference 232 between the first height 224 and the second height 230 should be sufficient to maintain a clearance between the propeller 212 on the aircraft 214 and the top surface 308 of the cowling 302 of less than about least eight (8) inches when the aircraft 214 is coupled to the apparatus 100.

In certain embodiments, the cowling 302 includes a pair of chain, belt or gearing covers 304a and 304b (collectively 304). The chain, belt or gearing covers 304 protect a chain, belt, or set of gears from the elements when the cowling 302 is positioned on the apparatus 100.

In one embodiment, the cowling 302 includes a recess 306 extending longitudinally along the cowling 302. The recess 306 is configured to receive the elongated strapping material 138 to protect the elongated strapping material 138 from contact with the propeller 212 on the aircraft 214.

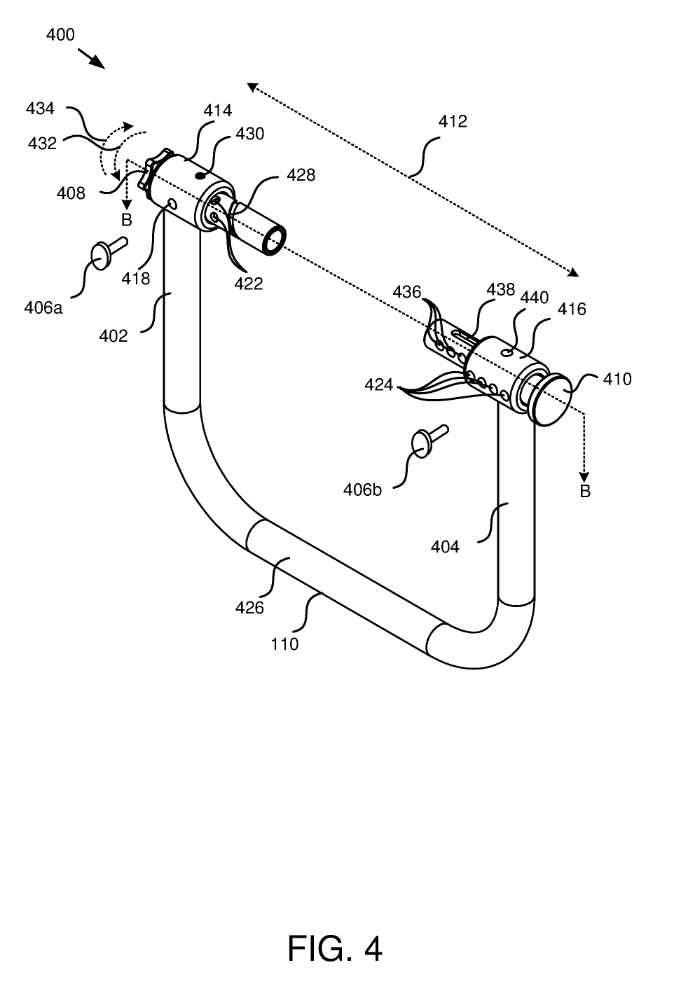

FIG. 4 is a perspective view further illustrating one embodiment of the aircraft engagement member 110 of FIG. 1 in accordance with the present subject matter. In certain embodiments, the aircraft engagement member 110 is an apparatus 400 coupleable to an aircraft wheel 216. While the embodiments described herein discuss the apparatus 400 as being coupleable to an aircraft wheel 216, one of skill in the art will recognize that in other embodiments, the apparatus 400 may be coupleable to wheels on other vehicles (i.e., a car wheel, motorcycle wheel, bicycle wheel, etc.)

The apparatus 400, in certain embodiments, includes a first support 402, a second support 404, and at least one locking element 406a and 406b (collectively 406). The first support 402 supports a first wheel coupling member 408. The second support 404 supports a second wheel coupling member 410.

In certain embodiments, the first support 402 is positioned opposite and parallel to the second support 404 such that the first wheel coupling member 408 is positioned opposite the second wheel coupling member 410. In the embodiment illustrated in FIG. 4, the first support 402 and the second support 404 are separated by a cross support 426 such that the apparatus is substantially U-shaped. In other embodiments, the apparatus 400 may be any other shape that positions the first wheel coupling member 408 opposite the second wheel coupling member 410 (i.e., Y-shaped).

In one embodiment, a first sleeve 414 is coupled to the first support 402 and a second sleeve 416 is coupled to the second support 404. The first sleeve 414 is sized to slideably receive the first wheel coupling member 408 and the second sleeve 416 sized to slideably receive the second wheel coupling member 410. The first wheel coupling member 408 is slideable within the first sleeve 414 such that the first wheel coupling member 408 can be repositioned within the first sleeve 414 in the direction indicated by arrow 412. The second wheel coupling member 410 is slideable within the second sleeve 416 such that the second wheel coupling member 410 can be repositioned within the second sleeve 416 in the direction indicated by arrow 412. In other embodiments only one of the first wheel coupling member 408 or the second wheel coupling member 410 is slideable within it's respective sleeve 414, 416 while the other is fixed in place. In this manner, at least one of the first wheel coupling member 408 and the second wheel coupling member 410 is movable to adjust a distance between the first wheel coupling member 408 and the second wheel coupling member 410.

In certain embodiments, the first wheel coupling member 408 and the second wheel coupling member 410 are tubular and are configured to receive opposing ends of an axle on the aircraft wheel 216. In other embodiments, the first wheel coupling member 408 and the second wheel coupling member 410 are configured to receive opposing ends of a towing attachment on a wheel pant 218 (see FIG. 2A) that covers the aircraft wheel 216. In yet another embodiment, the first wheel coupling member 408 and the second wheel coupling member 410 are sized and shaped to be received within opposing orifices in the wheel pant 218.

The locking elements 406 are configured to lock at least one of the first wheel coupling member 408 and the second wheel coupling member 410 in position and to limit further movement of the first wheel coupling member 408 and/or the second wheel coupling member 410 once the first wheel coupling member 408 and the second wheel coupling member 410 have engaged the axle of the aircraft wheel 216 or the wheel pant 218.

In certain embodiments, the locking elements 406a and 406b are pins that are positionable through orifices 418 or 420 in the first sleeve 414 and the second sleeve 416 respectively. The locking elements 406a and 406b are also positionable through orifices 422 and 424 in the first wheel coupling member 408 and the second wheel coupling member 410 respectively to limit movement of the first wheel coupling member 408 and the second wheel coupling member 410 within the first sleeve 414 and the second sleeve 416 respectively. In this manner, once the first wheel coupling member 408 and the second wheel coupling member 410 have engaged the axle of the aircraft wheel 216 or the wheel pant 218, the apparatus 400 is coupled to the aircraft wheel 216.

In one embodiment, the first coupling member 408 includes a helical recess 428 disposed about an outer surface of the first coupling member 408. In such an embodiment, the first sleeve 414 includes a recess engaging element 430. In one embodiment, the recess engaging element 430 is a screw that extends through the first sleeve 414 and is positioned in the recess 428. Rotation of the first coupling member 408 slides the helical recess 428 along the recess engaging element 430. Rotation of the first coupling member 408 in a first direction 432 slides the first coupling member 408 within the first sleeve 414 towards the second coupling member 410. Rotation of the first coupling member 408 in a second direction 434 opposite the first direction 432 slides the first coupling member 408 within the first sleeve 414 away from the second coupling member 410.

In one embodiment, the orifices 422 in the first coupling member 408 are helically arranged and the locking element 406 is positionable through the orifice 418 in the first sleeve 414 to selectively engage at least one of the orifices 422 in the series of helically arranged orifices 422 to lock the first coupling member 408 in position within the first sleeve 414. Arranging the orifices 422 in the first coupling member 408 helically allows for smaller incremental changes in the distance between the first coupling member 408 and the second coupling member 410 than would otherwise be achieved if the orifices 422 in the first coupling member 408 were arranged linearly.

In an exemplary embodiment, the second coupling member 410 includes a series of longitudinally arranged orifices 424. The locking member 406 is positionable through one of the orifices 424 in the second sleeve 416 to selectively engage at least one of the orifices 424 in the series of longitudinally arranged orifices 424 to lock the second coupling member 410 in position within the second sleeve 416. In one embodiment, the second coupling member includes a linear recess or groove 438. In such an embodiment, the second sleeve 416 includes a recess engaging element 440. In one embodiment, the recess engaging element 440 is a screw that extends through the second sleeve 416 and is positioned in the recess or groove 438. The linear recess or groove 438 in cooperation with the recess engaging element 440 maintain rotational alignment of the orifices 424 in the second sleeve 416 with the orifices 424 in the series of longitudinally arranged orifices 424 in the second coupling member 410.

In use the apparatus 400 may be centered about the aircraft wheel 216 by positioning the apparatus 400 with the first support 402 and the second support 404 located on either side of the aircraft wheel 216. The first coupling member 408 is rotated to adjust the apparatus 400 such that the aircraft wheel 216 is approximately centered between the first support 402 and the second support 404. The locking member 406a is then positioned through the orifice 418 in the first sleeve 414 and is positioned through the appropriate orifice 422 in the series of helically arranged orifices 422 to lock the first coupling member 408 in position within the first sleeve 414. The second coupling member 410 is then slid in the direction of the first coupling member 408 to engage the axle of the aircraft wheel 216 or the wheel pant 218. The locking member 406b is positioned through the appropriate orifices 424 in the second sleeve 416 to selectively engage the appropriate orifice 424 in the series of longitudinally arranged orifices 424 to lock the second coupling member 410 in position within the second sleeve 416. In this manner, the apparatus 400 is approximately centered about the aircraft wheel 216 or the wheel pant 218.

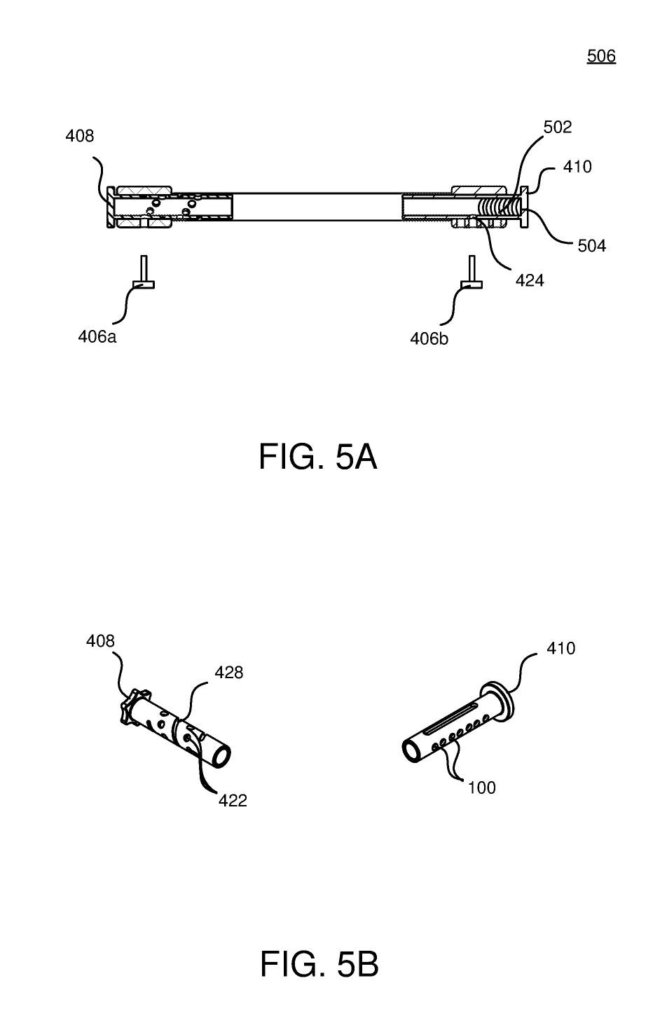

To remove the apparatus 400 from the aircraft wheel 216 or the wheel pant 218, the user simply removes the locking member 406b from within the orifice 424 in the series of longitudinally arranged orifices 424 in the second coupling member 410. The second coupling member 410 is slid away from the first coupling member 408 to allow the apparatus 400 to be removed from the aircraft wheel 216 or the wheel pant 218. In certain embodiments, the apparatus includes a biasing member 502 (see FIG. 5A) configured to bias the second coupling member 410 in an extended position 506 (see FIG. 5A) wherein the second coupling member 410 is positioned further away from the first coupling member 408.

FIG. 5A is a top cutaway view taken along line B-B of FIG. 4 further illustrating the apparatus 400 coupleable to a wheel in accordance with the present subject matter. In the embodiment illustrated in FIG. 5A, the biasing member 502 is clearly illustrated. In certain embodiments, the biasing member 502 is a spring positioned within the second coupling member 410. In such an embodiment, one end of the biasing member 502 rests against an internal end wall 504. The other end of the biasing member 502 is engaged with the recess engaging element 440 that extends through the second sleeve 416 and is positioned in the recess or groove 438. When the locking member 406b is removed from within the orifice 424 in the series of longitudinally arranged orifices 424 in the second coupling member 410, the biasing member 502 biases the second coupling member in an extended position 506 as shown in FIG. 5A.

FIG. 5B is a perspective view further illustrating one embodiment of the first coupling member 408 and the second coupling member 410 in accordance with the present subject matter. In the embodiment illustrated in FIG. 5B, the helical recess 428 and the helical arrangement of the orifices 422 of the first coupling member 408 are clearly illustrated. In certain embodiments, a handle 508 of the first coupling member 408 is contoured to facilitate rotation of the first coupling member 408. Also clearly illustrated in FIG. 5B are the linearly arranged orifices 436 and the recess or groove 438 of the second coupling member 410.

In the embodiments above, the apparatus 100 and the aircraft engagement member 110 are described with reference to towing an airplane. However, one of skill in the art will recognize that tugs are often used to tow other aircraft such as a helicopter. Accordingly, in certain embodiments, the apparatus 100 may include means for towing a helicopter rather than an airplane. Similarly, tugs are also used to tow other wheeled vehicles. The following discussion relates to a towing apparatus designed to interchangeably tow wheeled vehicles.

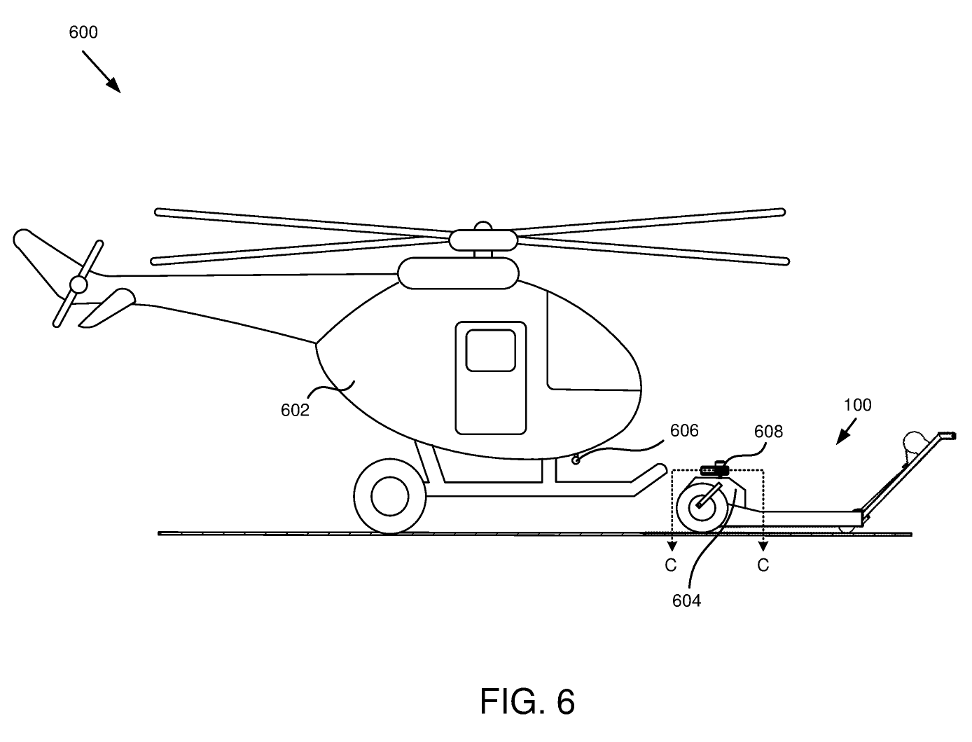

FIG. 6 is a side view illustrating one embodiment of an interchangeable towing apparatus 600 in accordance with the present subject matter. The apparatus 600 may be used to tow an airplane 214, a helicopter 602, a trailer, a car, or any other wheeled item.

A helicopter 602 is typically towed or moved using a tug specifically designed to couple to a ball 606 extending from the bottom of the helicopter 602. However, helicopter pilots often fly both helicopters 602 and airplanes 214. Additionally, the pilot may own other wheeled vehicles (i.e., cars, trailers, etc.) that the pilot wishes to move. Accordingly, in certain embodiments, the apparatus 100 of FIG. 1 may include an insert 604 configured to selectively couple to various wheeled vehicles. In one embodiment, the insert 604 includes an interchangeable towing apparatus 608 configured to tow whichever wheeled vehicle the user desires. In certain embodiments, a height of the insert 604 is manually or electrically adjustable to lift or lower the insert 604. The insert 604 includes an interchangeable towing connector 610.

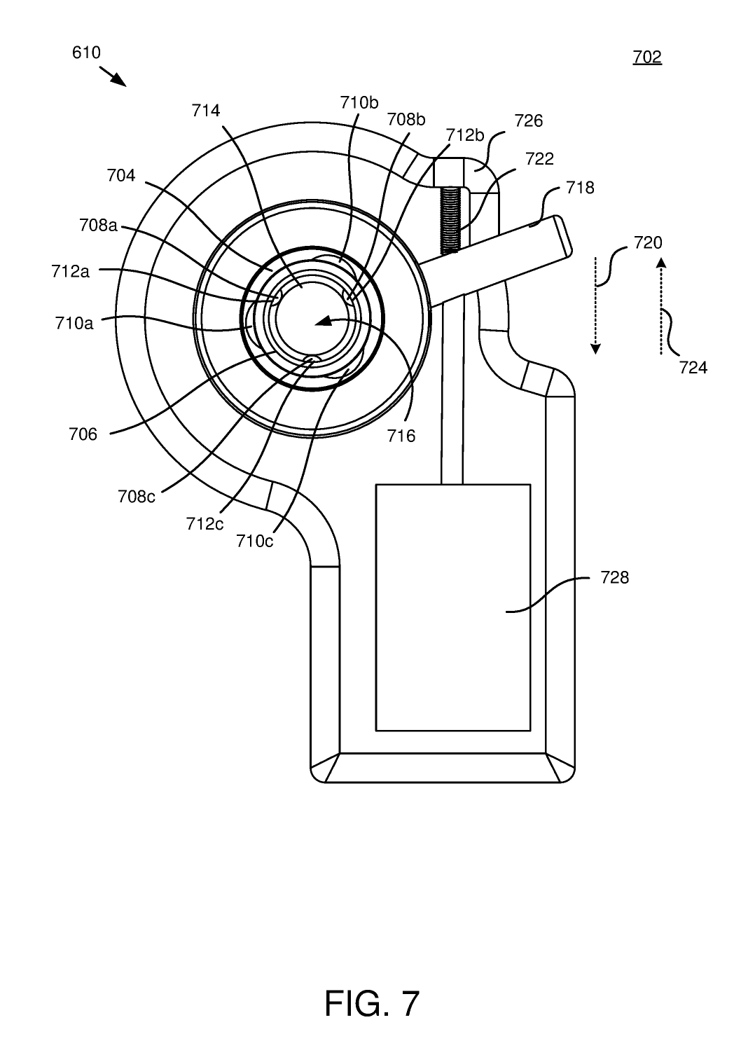

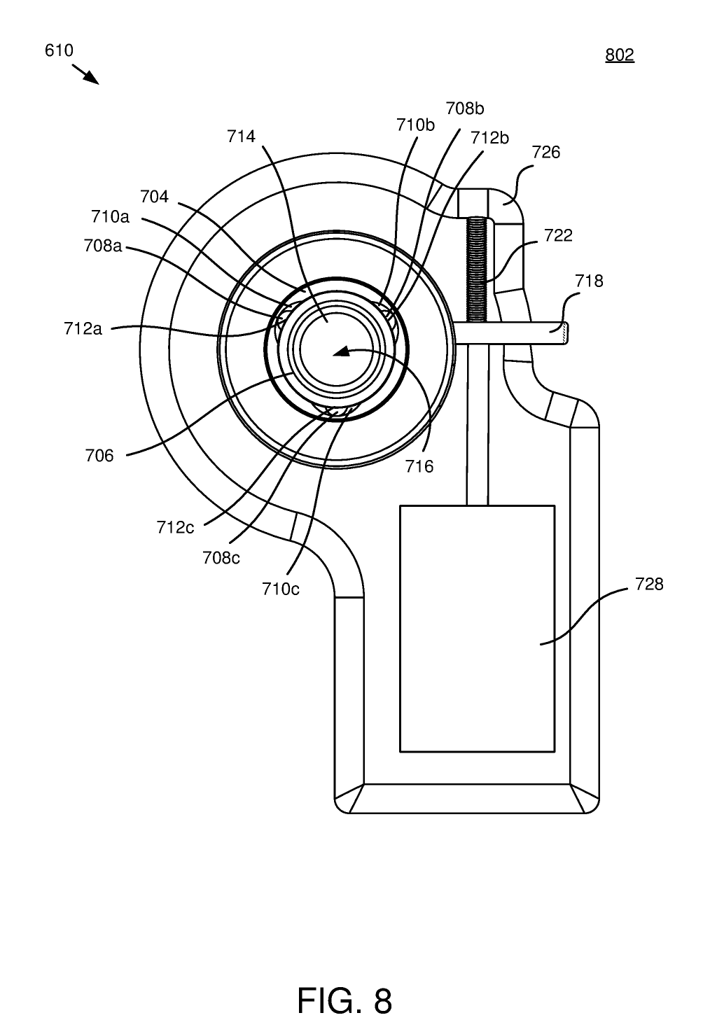

FIG. 7 depicts a top cutaway view taken along line C-C of FIG. 6 further illustrating the interchangeable towing connector 610 in a closed position 702 in accordance with the present subject matter. FIG. 8 depicts a top cutaway view taken along line C-C of FIG. 6 further illustrating the interchangeable towing connector 610 in an open position 802 in accordance with the present subject matter. The towing connector 610, in certain embodiments, includes a cylindrical outer race 704, a substantially cylindrical inner race 706, and at least one ball bearing 708a-708c (collectively 708).

In one embodiment, the outer race 704 includes at least one tapered recess 710a-710c (collectively 710). The inner race 706 is positioned within the outer race 704. The inner race includes at least one orifice 712a-712c (collectively 712) sized to receive the ball bearings 708. The ball bearings 708 are positioned between the outer race 704 and the inner race 706. Rotation of the outer race 704 around the inner race 706 displaces the ball bearings 708 between an open position 802 (see FIG. 8) and a closed position 702 as illustrated in FIG. 7.

In the closed position 702, the ball bearings 708 extend through the orifices 712 extending through the inner race 706. The orifices 712 are sized slightly smaller than the ball bearings 708 such that the ball bearings partially extend through the inner race 706 when the outer race 704 is rotated to the closed position 702. In the open position 802, the ball bearings 708 are positioned within the tapered recesses 710 in the outer race 704.

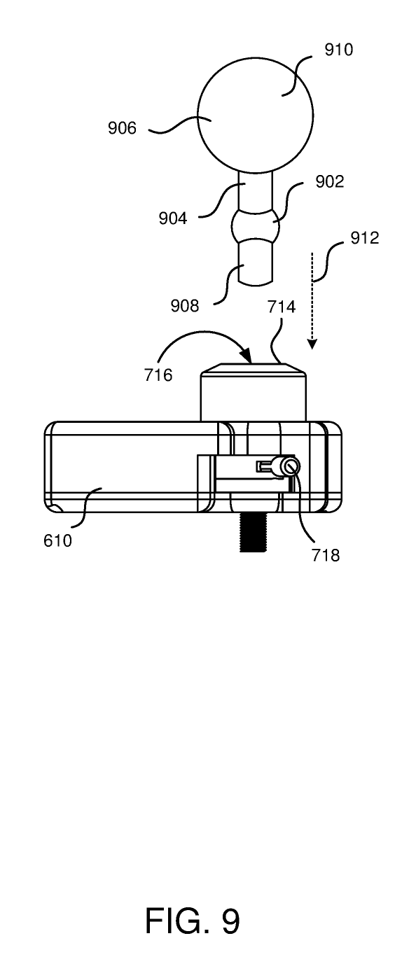

The inner race 706 includes a connecter receiving end 714 disposed opposite a shaft receiving end 716. In the embodiments illustrated in FIGS. 7 and 8 the connecter receiving end 714 is the end of the inner race 706 closest to the viewer and the shaft receiving end 716 is the end of the inner race 706 furthest from the viewer. The connecter receiving end 714 is sized to receive a connecting member (i.e., the ball 606 extending from the bottom of the helicopter 602 or a lobe 902 (see FIG. 9) on a shaft 904 (see FIG. 9) of an interchangeable tow ball 906 (see FIG. 9)). The shaft receiving end 716 is sized to receive an end 908 (see FIG. 9) of the shaft 904 of the interchangeable tow ball 906.

The interchangeable towing apparatus 610, in certain embodiments, also includes a lever 718 coupled to the outer race 704. In such an embodiment, the inner race 706 is rotationally stationary with respect to the outer race 704 and the lever 718 is configured to facilitate rotation of the outer race 704 about the inner race 706. Moving the lever 718 in the direction indicated by arrow 720 rotates the outer race 704 to the open position 802 as illustrated in FIG. 8. In the open position 802, the ball bearings 708 are received within the tapered recesses 710. With the ball bearings 708 positioned within the tapered recesses 710, the ball bearings 708 do not extend through the orifices 712 in the inner race 706.

In another embodiment, the interchangeable towing apparatus 610 includes a biasing spring 722 coupled to the lever 718. The biasing spring 722 is also coupled to a housing 726 of the interchangeable towing apparatus 610. The biasing spring 722 biases the lever 718 in the direction indicated by arrow 724 to rotate the outer race 704 to the closed position 702.

In yet another embodiment, the interchangeable towing apparatus 610 also includes an actuator 728 coupled to the lever 718. The actuator 728 is configured to rotate the outer race 704 to the open position 702. In an exemplary embodiment, the actuator 728 is a solenoid coupled to the lever 718. In such an embodiment, the lever 718 can be manually or electronically manipulated.

FIG. 9 is a side view illustrating one embodiment of the interchangeable towing connector 610 in accordance with the present subject matter. As discussed above, in certain embodiments, the interchangeable towing connector 610 is coupleable to ball 606 extending from the bottom of the helicopter 602. In other embodiments, the interchangeable towing connector 610 also includes at least one interchangeable tow ball 906.

The interchangeable tow ball 906 includes a shaft 904 having a lobe 902 disposed thereon. A conventionally sized tow ball 906 extends from one end of the shaft 904. Both the tow ball 906 and the lobe are at least semi-spherical. The tow ball 906 can be used to tow a trailer or other wheeled vehicle.

The opposite end 908 of the shaft 904 is substantially cylindrical. In use, the shaft 904 is positioned within the shaft receiving end 716 of the inner race 706 in the direction indicated by arrow 912. Once the lobe 902 on the shaft 904 encounters the ball bearings 708, the shaft 904 cannot be positioned any deeper into the inner race 706 without rotating the outer race 704 to the open position 802. To position the outer race 704 into the open position 802, either the actuator 728 is actuated or the lever 718 is depressed to allow the ball bearings 708 to be positioned in the tapered recesses 710 in the outer race 704. With the ball bearings 708 positioned in the tapered recesses 710 in the outer race 704, the lobe 902 on the shaft can slide past the ball bearings 708. The extending end 908 of the shaft 904 is positioned within the shaft receiving end 716 of the inner race 706 to limit side to side movement of the tow ball 906. Thus, the extending end 908 of the shaft 904, once it is positioned within the shaft receiving end 716, maintains the tow ball 906 at a position directly above the center of the inner race 706 without side to side movement of the tow ball 906.

Releasing the lever 718 rotates the outer race 704 to the closed position 702 and forces the ball bearings 708 to partially extend through the orifices 712 in the inner race 706. Withdrawal of the shaft 904 is prohibited by the ball bearings 708 interfering with the lobe 902 on the shaft 904. In this manner, the interchangeable tow ball 906 can be quickly and easily swapped out for another interchangeable tow ball 906 having a different sized tow ball 906.

While the embodiments described herein relate to an interchangeable towing apparatus 610 for use with an apparatus 100 for moving an aircraft, one of skill in the art will recognize that in other embodiments, the interchangeable towing apparatus 610 may be used with a conventional towing device. For example, in one embodiment, the interchangeable towing apparatus 610 may be used with a receiver hitch on a truck or car.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An aircraft tug for moving an aircraft having at least one aircraft wheel, the aircraft tug comprising:
an elongated support frame having a wheel receiving recess shaped to receive the at least one aircraft wheel;
at least one tug wheel supporting the elongated support frame; and
a loading platform configured to support the at least one aircraft wheel, wherein the loading platform is disposed at a height relative to the elongated support frame that is sufficient to avoid interference between a propeller on the aircraft and the elongated support frame when the at least one aircraft wheel is positioned on the loading platform.

2. The aircraft tug of claim 1, wherein the elongated support frame has a top surface and wherein the loading platform has an aircraft wheel support surface, wherein the top surface of the elongated support frame is positioned at a first height and wherein the aircraft wheel support surface of the loading platform is positioned at a second height.

3. The airplane tug of claim 2, wherein a difference between the first height and the second height is sufficient to support the aircraft at a position that avoids interference between the propeller on the aircraft and the top surface of the elongated support frame.

4. The aircraft tug of claim 2, wherein a difference between the first height and the second height is less than about 7 inches.

5. The aircraft tug of claim 2, wherein a difference between the first height and the second height is about five inches.

6. The aircraft tug of claim 2, wherein the first height is approximately a same height as the second height.

7. The aircraft tug of claim 2, wherein the first height is higher than the second height.

8. The aircraft tug of claim 2, wherein the first height is less than about eight inches.

9. The aircraft tug of claim 2, wherein the second height is greater than about one inch.

10. The aircraft tug of claim 2, wherein the first height is about seven inches and the second height is about two inches.

11. The aircraft tug of claim 2, further comprising a cowling configured to cover the elongated support frame, wherein a difference between the first height and the second height is sufficient to support the aircraft at a position that avoids interference between the propeller on the aircraft and a top surface of the cowling.

12. An apparatus for moving an aircraft having at least one aircraft wheel, the apparatus comprising:
an elongated support frame having a wheel receiving recess shaped to receive the at least one aircraft wheel, the elongated support frame having a top surface positioned at a first height;
at least one tug wheel supporting the elongated support frame; and
a loading platform disposed within the wheel receiving recess, the loading platform configured to support the at least one aircraft wheel on an aircraft wheel support surface positioned at a second height, wherein a difference between the first height and the second height is sufficient to support the aircraft at a position that avoids interference between the propeller on the aircraft and the top surface of the elongated support frame.

13. The apparatus of claim 11, wherein a difference between the first height and the second height is less than about seven inches.

14. The apparatus of claim 11, wherein a difference between the first height and the second height is about five inches.

15. The apparatus of claim 11, wherein the first height is approximately a same height as the second height.

16. The apparatus of claim 11, wherein the first height is less than about eight inches.

17. The apparatus of claim 15, wherein the second height is greater than about two inches.

18. The apparatus of claim 11, further comprising a cowling configured to cover the elongated support frame, wherein a difference between the first height and the second height is sufficient to support the aircraft at a position that avoids interference between the propeller on the aircraft and a top surface of the cowling.

19. The apparatus of claim 9, further comprising a winch having an elongated strapping material, wherein the winch is configured to draw the at least one aircraft wheel onto the loading platform, wherein the cowling includes a recess extending longitudinally along the cowling, the recess configured to receive the elongated strapping material to protect the elongated strapping material from contact with the propeller on the aircraft.

20. An apparatus for moving an aircraft having at least one aircraft wheel, the apparatus comprising:
an elongated support frame having a wheel receiving recess shaped to receive the at least one aircraft wheel, the elongated support frame having a top surface positioned at a first height less than about eight inches;
at least one tug wheel supporting the elongated support frame; and
a loading platform disposed within the wheel receiving recess, the loading platform configured to support the at least one aircraft wheel on an aircraft wheel support surface positioned at a second height greater than about two inches, wherein a difference between the first height and the second height is sufficient to support the aircraft at a position that avoids interference between the propeller on the aircraft and the top surface of the elongated support frame
